(19) United States
(12) Patent Application Publication
(10) Pub. No.: US 2014/0289485 A1
(43) Pub. Date: Sep. 25, 2014

(54) STORAGE SYSTEM, CONTROL APPARATUS, AND METHOD FOR CONTROLLING STORAGE SYSTEM

(71) Applicant: FUJITSU LIMITED, Kawasaki-shi (JP)

(72) Inventor: Yusuke Inai, Kawasaki (JP)

(73) Assignee: FUJITSU LIMITED, Kawasaki-shi (JP)

(21) Appl. No.: 14/134,820

(22) Filed: Dec. 19, 2013

(30) Foreign Application Priority Data
Mar. 22, 2013 (JP) 2013-059758

(51) Int. Cl. G06F 3/06

(52) U.S. Cl. CPC G06F 3/065; G06F 3/0604; G06F 3/0683
USPC 711/162

(57) ABSTRACT

A storage system includes a library apparatus, a storage apparatus, and a control apparatus including a processor. The processor is configured to execute a copy processing of copying data of a plurality of logical volumes from a storage apparatus to a first recording medium. The copy processing includes a read processing of reading first data of a first logical volume from the storage apparatus, and a first write processing of writing the first data to the first recording medium. The processor is configured to execute a second write processing of writing second data of the first logical volume to the storage apparatus. The processor is configured to interrupt the first write processing and execute the second write processing in a case where a conflict occurs between the second write processing and the first write processing, and resume the copy processing from a leading part of the first logical volume.

### CROSS-REFERENCE TO RELATED APPLICATION

This application is based upon and claims the benefit of priority of the prior Japanese Patent Application No. 2013-059758 filed on Mar. 22, 2013, the entire contents of which are incorporated herein by reference.

### FIELD

The embodiments discussed herein are related to a storage system, a control apparatus, and a method for controlling a storage system.

### BACKGROUND

A magnetic tape, an optical disc, an opto-magnetic disc, and the like are used as a portable recording medium. Particularly, the magnetic tape is utilized as a recording medium that realizes a back-end large-capacity storage area in a storage system. The storage system that utilizes the magnetic tape for the back-end storage area is called, for example, “virtual tape system” or the like.

In some of the virtual tape systems, logical volume data recorded in the magnetic tape stored in the library apparatus is recorded, as a type of backup processing, on a magnetic tape for external ejection so as to save the magnetic tape for external ejection outside of the systems. The processing of writing the data on the magnetic tape for external ejection is called, for example, “export processing” or the like.

On the other hand, the amount of data to be stored in the storage system has been increased in recent years, and an improvement in a processing capacity is demanded to realize a high speed storage of a long stream of backup data.

In some systems, for example, priority processing on a read and write request with respect to a medium volume having a high priority is executed depending on a load status of a host interface, and a processing delay in an important volume is avoided even in a case where a load of the host interface is high.

In other systems, for example, when a data redundancy is realized by copying a logical volume in an external storage apparatus to a logical volume in another external storage apparatus, the number of logical volumes that execute the simultaneous copy is controlled so that a performance deterioration of In/Out (I/O) processing from a higher rank apparatus during the copy processing is avoided.

Related techniques are disclosed in, for example, Japanese Laid-open Patent Publication No. 2006-215615 and Japanese Laid-open Patent Publication No. 2000-137582.

In the virtual tape system, read or write of data is executed in accordance with an I/O request from a host. When the I/O request is issued from the host during the execution of the export processing, the export processing and the write in response to the request from the host may conflict against each other with respect to same data (logical volume) on a cache.

In a case where the above-mentioned conflict occurs, up to now, the write in response to the request from the host is prioritized and executed, and on the other hand, the entire export processing is aborted and thereafter freshly started. Thus, this method has a problem in that a time spent to complete the export processing is lengthened.

Since the amount of data to be backed up has been increased in recent years, it is being difficult to carry out the export processing during a period where no I/O request is issued from the host. For that reason, the above-mentioned problem is becoming prominent.

### SUMMARY

According to an aspect of the present invention, provided is a storage system including a library apparatus, a storage apparatus, and a control apparatus. The library apparatus is configured to store therein a plurality of portable recording media. The library apparatus is configured to read data from or write data to the plurality of portable recording media. The storage apparatus is configured to temporarily store therein data of a logical volume. The stored data is to be recorded on a recording medium among the plurality of portable recording media. The control apparatus includes a processor. The processor is configured to execute a copy processing of copying data of a plurality of logical volumes from the storage apparatus to a first recording medium among the plurality of portable recording media. The copy processing includes a read processing of reading first data of a first logical volume among the plurality of logical volumes from the storage apparatus, and a first write processing of writing the first data to the first recording medium. The processor is configured to execute a second write processing of writing second data of the first logical volume to the storage apparatus. The processor is configured to interrupt the first write processing and execute the second write processing in a case where a conflict occurs between the second write processing and the first write processing during execution of the copy processing. The processor is configured to invalidate data written to the first recording medium through the interrupted first write processing. The processor is configured to resume the copy processing from a leading part of the first logical volume.

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary configuration and an exemplary operation of a storage system according to a first embodiment;

FIG. 2 illustrates an exemplary system configuration of a storage system according to a second embodiment;

FIG. 3 illustrates an exemplary hardware configuration of a control apparatus;

FIG. 4 illustrates an exemplary hardware configuration of a tape library apparatus;

FIG. 5 is a block diagram illustrating an example of a processing function provided to a control apparatus;

FIG. 6 illustrates exemplary tables included in a configuration information storage unit;

FIG. 7 illustrates an exemplary configuration of a cache information management table;

FIG. 8 illustrates an exemplary configuration of an LV information management table;

FIG. 9 illustrates an exemplary configuration of an EXPORT information management table;

FIG. 10 illustrates an exemplary configuration of an EXPORT LV information management table;

FIG. 11 illustrates an exemplary configuration of a tape drive information table;

FIG. 12 is a flow chart of an operation by a control apparatus;

FIG. 13 is a flow chart of an operation by a control apparatus; and

FIG. 14 is a flow chart in a case where export processing and host-write processing are executed in parallel with each other.

### DESCRIPTION OF EMBODIMENTS

Hereinafter, embodiments will be described with reference to the drawings.

### First Embodiment

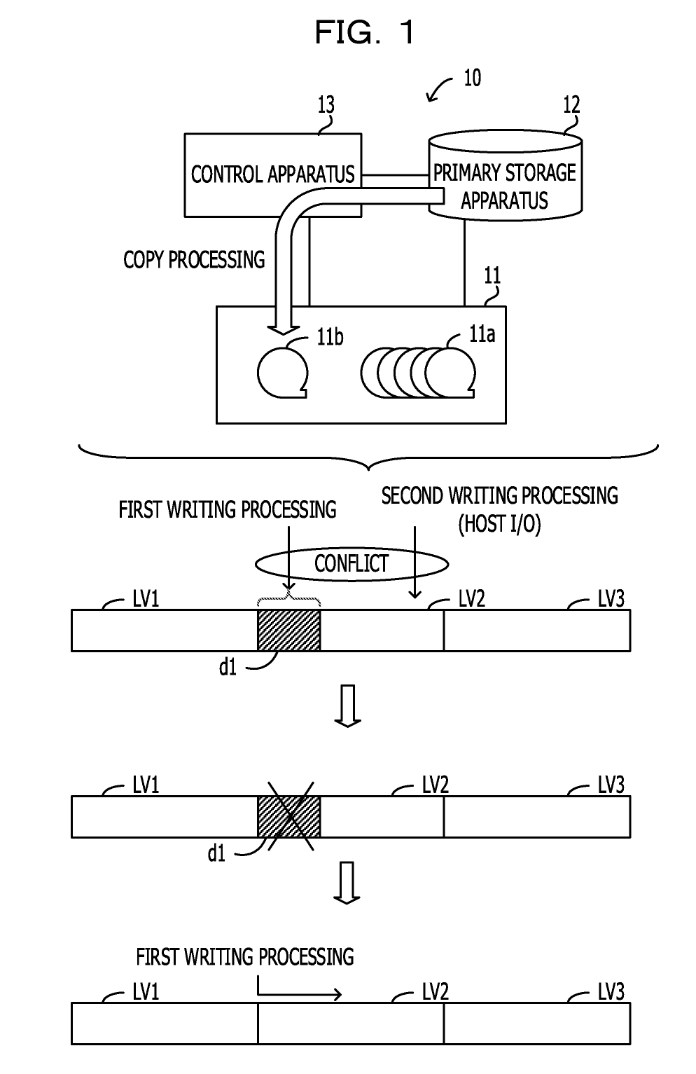

FIG. 1 illustrates an exemplary configuration and an exemplary operation of a storage system according to a first embodiment. A storage system 10 includes a library apparatus 11, a primary storage apparatus 12, and a control apparatus 13.

The library apparatus 11 stores plural portable recording media and uses the stored portable recording media to perform read or write of data. The library apparatus 11 includes, for example, one or more drive apparatuses that perform the read or write of the data by using the portable recording media.

The portable recording media are, for example, magnetic tapes. The portable recording media stored in the library apparatus 11 are generally classified into a secondary storage recording medium 11a used as a secondary storage of a hierarchical storage system and an external ejection recording medium 11b.

The primary storage apparatus 12 is a storage apparatus used as a primary storage of the hierarchical storage system. The primary storage apparatus 12 temporarily stores the data of the logical volume to be recorded in the secondary storage recording medium 11a among the portable recording media stored in the library apparatus 11.

The control apparatus 13 controls an operation of the hierarchical storage system including the primary storage and the secondary storage. The control apparatus 13 may execute copy processing of writing the data of the specified plural logical volumes from the primary storage apparatus 12 to the external ejection recording medium 11b. The external ejection recording medium 11b to which the data of the specified plural logical volumes has been written is ejected, for example, out of the library apparatus 11 and used in another storage system.

In a case where the data of the logical volume specified as a target of the copy processing is not stored in the primary storage apparatus 12, for example, the control apparatus 13 reads out the data from the secondary storage recording medium 11a in the library apparatus 11 and stores the data in the primary storage apparatus 12.

During the execution of the above-mentioned copy processing, in a case where first write processing of writing data of one logical volume among the specified plural logical volumes to the external ejection recording medium 11b and second write processing of writing data to the one logical volume conflict against each other, the control apparatus 13 interrupts the first write processing to execute the second write processing and invalidates the data of the one logical volume on the external ejection recording medium 11b to continue the copy processing from the leading part of this logical volume.

Here, a case will be described where logical volumes LV1, LV2, and LV3 are specified as targets of the copy processing as an example. After the processing of writing data of the logical volume LV1 to the external ejection recording medium 11b is completed, the control apparatus 13 starts the first write processing of writing data of the logical volume LV2 to the external ejection recording medium 11b. It is supposed that this first write processing and the second write processing of writing data to the logical volume LV2 conflict against each other. For example, the second write processing with respect to the logical volume LV2 occurs when data d1 in the logical volume LV2 is written to the external ejection recording medium 11b. The second write processing is, for example, processing (host I/O processing) in response to the I/O request from the host.

The control apparatus 13 interrupts the first write processing and executes the second write processing. Along with this, the control apparatus 13 invalidates the data d1 on the external ejection recording medium 11b and executes the first write processing with respect to the logical volume LV2 again to continue the copy processing from the leading part of the logical volume LV2. The invalidation of the data d1 means, for example, that the area where the data d1 has been recorded is overwritten by the data transferred from the primary storage apparatus 12 as the result of the continuation of the copy processing.

According to the above-mentioned storage system 10, it is possible to execute the second write processing within a short period of time by interrupting the first write processing to perform the second write processing. For example, a response may shortly be made to the host in a case where the second write processing is executed in response to the I/O request from the host.

For example, when the first write processing is interrupted, after the second write processing with respect to the conflicting logical volume is executed in the primary storage apparatus 12, the control apparatus 13 writes the logical volume updated through the second write processing to the external ejection recording medium 11b from the leading part. Alternatively, when the first write processing is interrupted, the control apparatus 13 may duplicate the data of the logical volume that conflicts in the primary storage apparatus 12. The control apparatus 13 may write one of the data of the duplicated logical volumes to the external ejection recording medium 11b from the leading part and may also execute, in parallel with this first write processing, the second write processing with respect to the other logical volume of the duplicated logical volumes. In either processing, the second write processing may be executed in a short period of time.

According to the above-mentioned storage system 10, after the first write processing with respect to the conflicting logical volume is interrupted, the data of the logical volume on the external ejection recording medium 11b is invalidated, and the copy processing is continued from the leading part of the logical volume. According to this, since the copy processing may be interrupted in units of logical volume while a consistency of the data of the conflicting logical volume is maintained, the copy processing may be resumed from a mid-course instead of the beginning.

In the example of FIG. 1, the copy processing may be resumed from the leading part of the logical volume LV2 instead of the logical volume LV1. In a case where the portable recording medium is the magnetic tape, for example, the copy processing may be resumed from a mid-course without rewinding the external ejection recording medium 11b to the leading part.

Therefore, it is possible to shorten the time used for the copy processing to the external ejection recording medium 11b.

Next, an embodiment in which the storage system 10 is applied to a virtual tape library system will be described.

### Second Embodiment

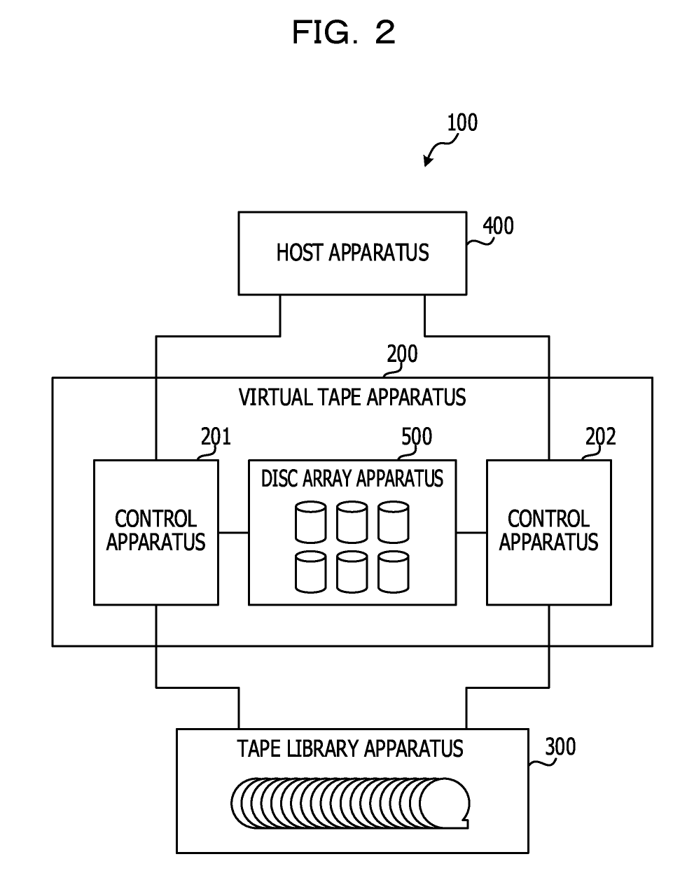

FIG. 2 illustrates an exemplary system configuration of a storage system according to a second embodiment. The storage system 100 includes a virtual tape apparatus 200, a tape library apparatus 300, and a host apparatus 400.

The tape library apparatus 300 (corresponding to the library apparatus 11 of FIG. 1) is a storage apparatus that uses a magnetic tape as a recording medium. As will be described below, the tape library apparatus 300 includes plural tape drives configured to perform a data access with respect to the magnetic tape, a mechanism configured to convey a tape cartridge that contains the magnetic tape, and the like.

The tape library apparatus 300 may be provided, for example, in a same casing that contains the virtual tape apparatus 200.

The virtual tape apparatus 200 includes control apparatuses 201 and 202 (each corresponding to the control apparatus 13 of FIG. 1) and a disc array apparatus 500 (corresponding to the primary storage apparatus 12 of FIG. 1). The disc array apparatus 500 is a storage apparatus including plural hard disk drives (HDDs).

According to the present embodiment, it is supposed that the control apparatuses 201 and 202 and the disc array apparatus 500 are provided in a same casing, but these apparatuses may be provided in individual casings.

The control apparatuses 201 and 202 control a data transfer operation between the host apparatus 400 and the disc array apparatus 500 and a data transfer operation between the disc array apparatus 500 and the tape library apparatus 300.

The control apparatuses 201 and 202 perform a control in a manner that the storage system 100 operates as a hierarchical virtual tape library system where the magnetic tape in the tape library apparatus 300 is set as a back-end library apparatus and the HDDs in the disc array apparatus 500 are set as a cache apparatus. The virtual tape library system mentioned herein is a system where a large-capacity storage area realized by the tape library apparatus 300 may virtually be utilized by the host apparatus 400 through the disc array apparatus 500.

A portable recording medium of another type such as, for example, an optical disc or an opto-magnetic disc other than the magnetic tape may also be used as the recording medium in the back end of the virtual tape library system. A storage apparatus of another type such as a solid state drive (SSD) other than the HDD may also be used as the cache apparatus in the virtual tape library system.

The control apparatus 201 and the control apparatus 202 control, for example, a data transfer operation with respect to mutually different logical volumes. In a case where a failure occurs in one of the control apparatuses 201 and 202, for example, the operation of the virtual tape library system may be continued by the other control apparatus alone.

The control apparatuses 201 and 202 may execute “export processing” of copying the data of the logical volume requested to be ejected from the host apparatus 400 to the magnetic tape for ejection and ejecting the magnetic tape out of the tape library apparatus 300. The logical volume in the magnetic tape ejected outside through the export processing may be utilized, for example, by another virtual tape library system.

The host apparatus 400 accesses the logical volume in the virtual tape library system by issuing an access request to at least one of the control apparatuses 201 and 202 in accordance with an input operation of a user. The host apparatus 400 may cause the control apparatuses 201 and 202 to execute the export processing on an arbitrary logical volume by specifying the logical volume.

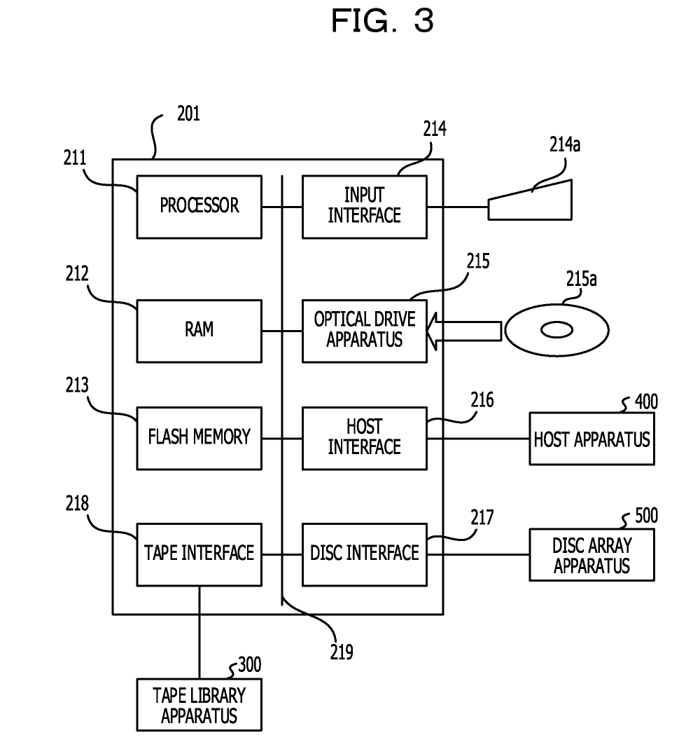

Next, a hardware configuration of the control apparatus 201 will be described. FIG. 3 illustrates an exemplary hardware configuration of a control apparatus. The control apparatus 201 and the control apparatus 202 has a similar hardware configuration and may execute similar processing. Therefore, hereinafter, the configuration and processing of the control apparatus 201 among the control apparatuses 201 and 202 will be described, and a description on the control apparatus 202 will be omitted.

The control apparatus 201 is realized, for example, as a computer illustrated in FIG. 3. The entirety of the control apparatus 201 is controlled by a processor 211. The processor 211 is, for example, a central processing unit (CPU), a micro processing unit (MPU), a digital signal processor (DSP), an application specific integrated circuit (ASIC), or a programmable logic device (PLD). The processor 211 may be a combination of two or more elements of the CPU, the MPU, the DSP, the ASIC, and the PLD.

A random access memory (RAM) 212 and plural peripheral devices are connected to the processor 211 via a bus 219.

The RAM 212 is used as a main storage apparatus of the control apparatus 201. The RAM 212 temporarily stores at least a part of programs (including firmware) executed by the processor 211. The RAM 212 also stores various data used for the processing by the processor 211.

The peripheral devices connected to the bus 219 include a flash memory 213, an input interface 214, an optical drive apparatus 215, a host interface 216, a disc interface 217, and a tape interface 218.

The flash memory 213 is used as a secondary storage apparatus of the control apparatus 201. The flash memory 213 stores programs and various data. A non-volatile storage apparatus of another type such as an HDD may be used for the secondary storage apparatus.

An input apparatus 214a provided with various operation keys and the like, for example, may be connected to the input interface 214. The input interface 214 transmits a signal received from the input apparatus 214a to the processor 211 via the bus 219. The input apparatus 214a may also be mounted to the control apparatus 201.

The optical drive apparatus 215 performs read of data recorded on an optical disc 215a by utilizing laser light or the like. The optical disc 215a is a portable recording medium on which the data is recorded so as to be read by a reflection of the light. For the optical disc 215a, for example, a digital versatile disc (DVD), a DVD-RAM, a compact disc read-only memory (CD-ROM), a CD-R (Recordable)/RW (Rewritable), or the like is used.

The host interface 216 is a communication interface that transmits and receives data with the host apparatus 400. The disc interface 217 is a communication interface that transmits and receives data with the disc array apparatus 500. The tape interface 218 is a communication interface that transmits and receives data with the tape library apparatus 300.

Similarly as in the control apparatus 201, the host apparatus 400 may also be realized as a computer provided with a CPU, a RAM, peripheral devices, and the like.

The processing functions according to the present embodiment may be realized by the above-mentioned hardware configuration. In a case where the processing functions according to the present embodiment are realized by a computer, a program in which processing contents of the functions that the control apparatus 201 has are described is provided. The program is executed by the computer, so that the above-mentioned processing functions are realized on the computer. The program in which the processing contents are described may be recorded on a computer-readable recording medium.

The computer-readable recording medium is, for example, a magnetic storage apparatus, an optical disc, an opto-magnetic recording medium, a semiconductor memory, or the like. The magnetic storage apparatus includes a hard disk drive (HDD), a flexible disc (FD), a magnetic tape, or the like. The optical disc includes a DVD, a DVD-RAM, a CD-ROM/RW, or the like. The opto-magnetic recording medium includes a magneto-optical disk (MO) or the like. It is noted that the recording medium on which the program is recorded does not include temporary propagation signals.

In a case where the program is to be circulated, for example, the portable recording medium such as the DVD or the CD-ROM on which the program is recorded is marketed. The program may be stored in a storage apparatus of a server computer, and the program may be transferred from the server computer to another computer via a network.

The computer configured to execute the program stores, for example, the program recorded on the portable recording medium or the program transferred from the server computer in its own storage apparatus. The computer then reads the program from its own storage apparatus and executes processing in accordance with the program.

The computer may also directly read the program from the portable recording medium and execute the processing in accordance with the program. Each time when the program is transferred from the server computer, the computer may also sequentially execute the processing in accordance with the received program.

At least a part of the above-mentioned processing functions may be realized by an electronic circuit such as a DSP, an ASIC, or a PLD.

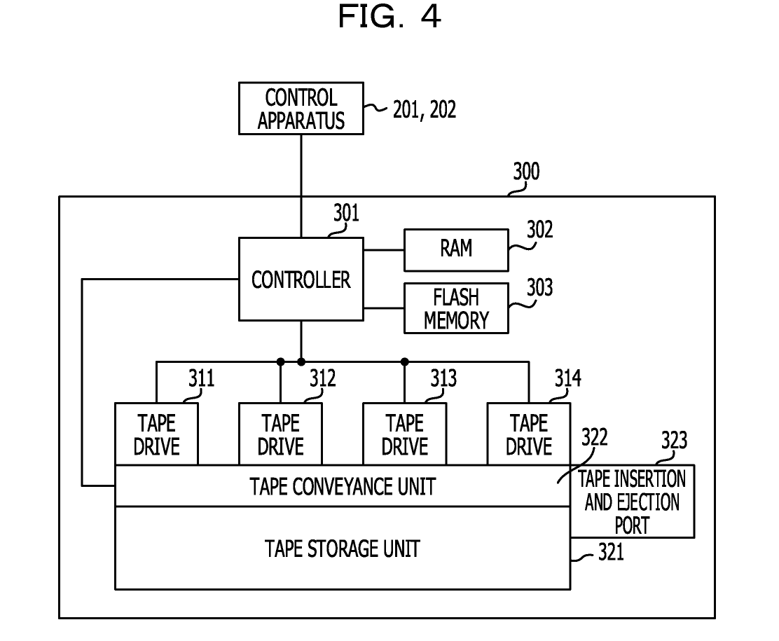

Next, a hardware configuration of the tape library apparatus 300 will be described. FIG. 4 illustrates an exemplary hardware configuration of a tape library apparatus. The tape library apparatus 300 includes a controller 301, a RAM 302, a flash memory 303, tape drives 311 to 314, a tape storage unit 321, a tape conveyance unit 322, and a tape insertion and ejection port 323.

The controller 301 includes, for example, a processor and controls the entirety of the tape library apparatus 300 in an overall manner. The RAM 302 temporarily stores therein at least a part of the programs to be executed by the controller 301. The RAM 302 also stores therein various data used for the processing conducted by the controller 301. The flash memory 303 stores the programs and various data.

The tape drives 311 to 314 respectively mount thereon tape cartridges conveyed by the tape conveyance unit 322 one by one and perform write of data with respect to the magnetic tape in the mounted tape cartridge and read of the data from the magnetic tape under the control of the controller 301.

According to the present embodiment, the tape library apparatus 300 includes the four tape drives as an example, but the number of the tape drives is not particularly limited.

The tape storage unit 321 stores therein plural tape cartridges. The tape cartridges stored in the tape storage unit 321 are roughly divided into tape cartridges used as a part of the virtual tape library system and tape cartridges used for an export purpose. The control apparatuses 201 and 202 decide on a usage of the magnetic tape as to whether the magnetic tape is used as a library magnetic tape corresponding to the magnetic tape in the former tape cartridge or an export magnetic tape corresponding to the magnetic tape in the latter tape cartridge.

The tape conveyance unit 322 conveys the tape cartridge under the control of the controller 301. The tape conveyance unit 322 conveys, for example, the tape cartridge stored in the tape storage unit 321 to one of the tape drives 311 to 314 to mount the tape cartridge thereto. The tape conveyance unit 322 also conveys the tape cartridge demounted from the tape drives 311 to 314 store the tape cartridge in the tape storage unit 321.

Furthermore, the tape insertion and ejection port 323 is arranged in the tape conveyance unit 322. The tape conveyance unit 322 ejects the tape cartridge conveyed from the tape drives 311 to 314 or the tape storage unit 321 out of the tape library apparatus 300 from the tape insertion and ejection port 323 in response to a request received from the controller 301. The tape conveyance unit 322 may also convey the tape cartridge inserted from the tape insertion and ejection port 323 to the tape drives 311 to 314 or the tape storage unit 321.

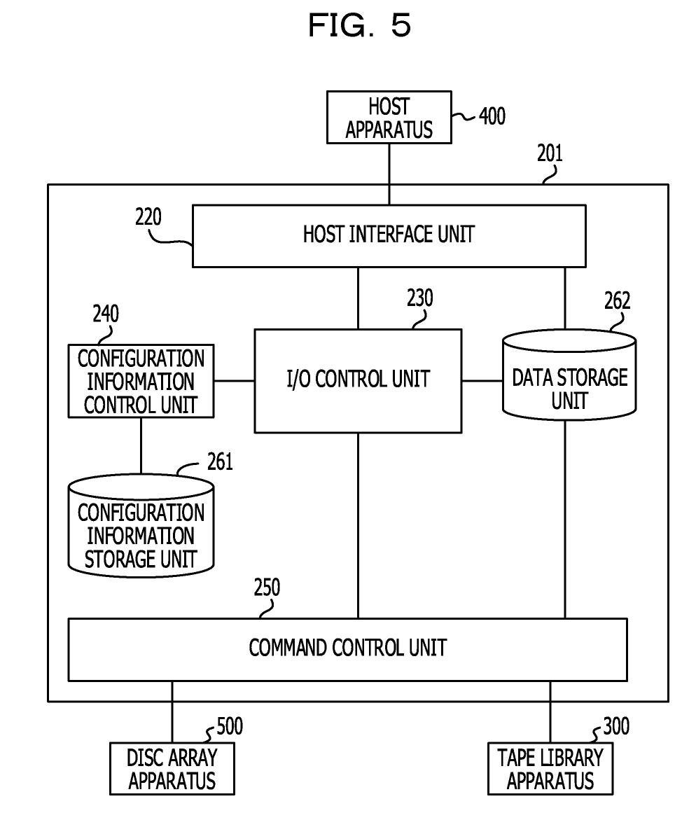

Next, a function block configuration of the control apparatus 201 will be described. FIG. 5 is a block diagram illustrating an example of a processing function provided to the control apparatus.

The control apparatus 201 includes a host interface unit 220, an I/O control unit 230, a configuration information control unit 240, and a command control unit 250. The processing of these respective units is realized, for example, while the processor 211 of the control apparatus 201 executes a predetermined program.

The control apparatus 201 also includes a configuration information storage unit 261 and a data storage unit 262. These storage areas are realized, for example, by the RAM 212 provided to the control apparatus 201.

The host interface unit 220 receives requests from the host apparatus 400 and transmits responses with respect to the requests to the host apparatus 400. The requests received from the host apparatus 400 include, for example, a host I/O request related to host I/O processing and an export request for requesting execution of the export processing.

The host I/O requests include, for example, a host write request for requesting “host write processing” of writing data to a specified logical volume and a host read request for requesting “host read processing” of reading data of the specified logical volume.

In a case where the request received from the host apparatus 400 is the host write request, the host interface unit 220 stores the data transmitted from the host apparatus 400 in the data storage unit 262. When the requested host write processing is executed by the I/O control unit 230, the host interface unit 220 transmits a completion notification of the host write processing to the host apparatus 400.

In a case where the request received from the host apparatus 400 is the host read request, the host interface unit 220 transmits the corresponding data stored in the data storage unit 262 to the host apparatus 400.

The export request includes information for specifying the logical volume set as a target of the export processing. When the export processing on all the specified logical volumes is executed by the I/O control unit 230, the host interface unit 220 transmits a completion notification of the export processing to the host apparatus 400.

The I/O control unit 230 diagnoses a request received from the host apparatus 400 by the host interface unit 220 and performs the following processing (a) to (d), for example, in accordance with the request content.

(a) Requesting the configuration information control unit 240 to change configuration information.

(b) Requesting the command control unit 250 to issue a command to the disc array apparatus 500 or the tape library apparatus 300.

(c) Diagnosing the command execution result responded from the command control unit 250 and the data stored in the data storage unit 262.

(d) Requesting the host interface unit 220 to issue a response to the host apparatus 400.

The configuration information control unit 240 updates or reads out information stored in the configuration information storage unit 261 in accordance with a request received from the I/O control unit 230.

The command control unit 250 issues a command to the disc array apparatus 500 or the tape library apparatus 300 in accordance with a request received from the I/O control unit 230. At this time, In the case of the write request, the command control unit 250 also transmits data stored in the data storage unit 262 to the disc array apparatus 500 or the tape library apparatus 300. In the case of the read request, the command control unit 250 stores data sent as the result of the command issuance in the data storage unit 262.

Herein, basic processing of the I/O control unit 230 will further be described. The controls conducted by the I/O control unit 230 include, for example, the control on the host I/O processing and the control on the export processing. The I/O control unit 230 accesses the disc array apparatus 500 or the magnetic tape in the tape library apparatus 300 by issuing an access request to the command control unit 250.

The host I/O processing is processing for the host apparatus 400 to access the data on the virtual tape library system and is controlled as follows.

When the host write processing is requested, the I/O control unit 230 updates the data of the logical volume set as the write target on the disc array apparatus 500. After the completion of the write is notified to the host apparatus 400, the I/O control unit 230 writes the updated data of the logical volume on the disc array apparatus 500 to the library magnetic tape in the tape library apparatus 300.

When the host read processing is requested, in a case where the data of the logical volume set as the read target is cached in the disc array apparatus 500, the I/O control unit 230 reads out the requested data from the disc array apparatus 500. On the other hand, in a case where the data of the logical volume set as the read target is not cached in the disc array apparatus 500, the I/O control unit 230 transfers the requested data from the library magnetic tape to the disc array apparatus 500 and thereafter reads out this data from the disc array apparatus 500. The I/O control unit 230 transmits the read data to the host apparatus 400 via the host interface unit 220.

The export processing is controlled as follows. The I/O control unit 230 transfers the data of the logical volume set as the target of the export processing from the disc array apparatus 500 to the tape library apparatus 300 to write this data in the export magnetic tape. In a case where the data of the specified logical volume is not cached in the disc array apparatus 500, the I/O control unit 230 transfers the requested data from the library magnetic tape to the disc array apparatus 500 and thereafter transfers this data from the disc array apparatus 500 to the tape library apparatus 300 to write this data in the export magnetic tape.

The I/O control unit 230 determines whether or not the data of the logical volume set as the target of the host I/O processing or the export processing is cached in the disc array apparatus 500 by referring to a cache information management table which will be described below.

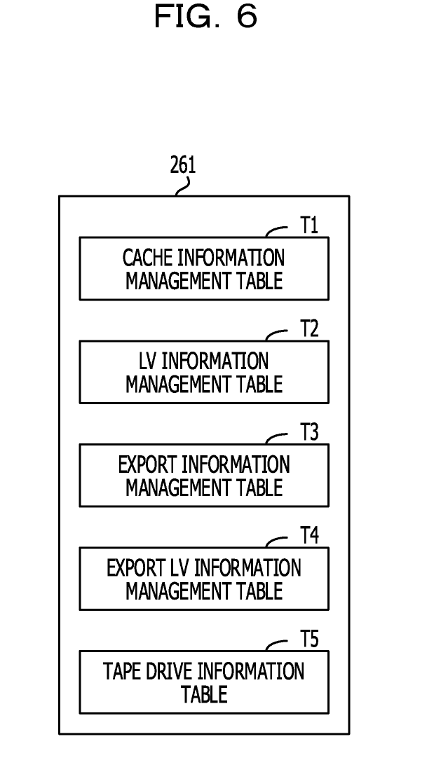

Next, various tables stored in the configuration information storage unit 261 will be described. FIG. 6 illustrates an exemplary tables included in a configuration information storage unit. The configuration information storage unit 261 includes a cache information management table T1, an LV information management table T2, an EXPORT information management table T3, an EXPORT LV information management table T4, and a tape drive information table T5.

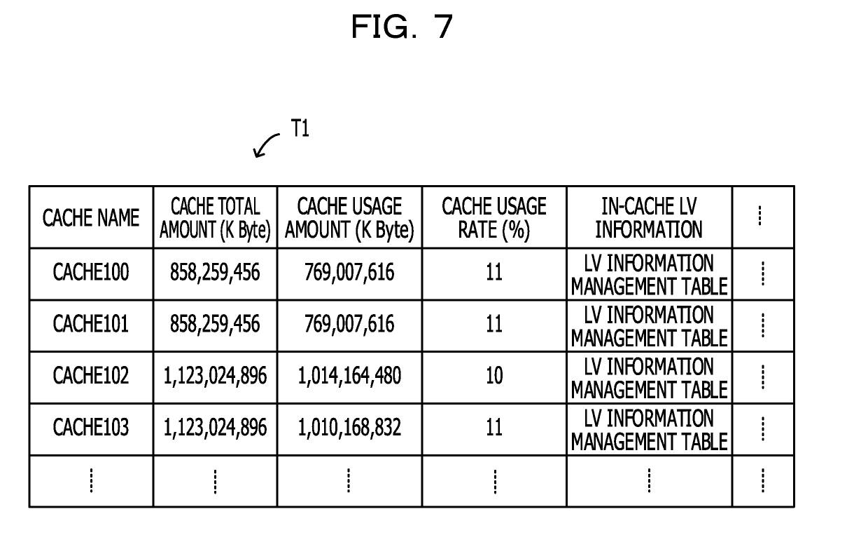

FIG. 7 illustrates an exemplary configuration of a cache information management table. “Cache name”, “cache total amount (K Byte)”, “cache usage amount (K Byte)”, “cache usage rate (%)”, and “in-cache LV information” are registered in the cache information management table T1 as management information of each cache area on the disc array apparatus 500.

The “cache name” is information for identifying a cache area. A storage area of the disc array apparatus 500 is divided into cache areas. The “cache total amount (K Byte)” is a storage total capacity of the cache area. The “cache usage amount (K Byte)” is a capacity of data stored in the cache area.

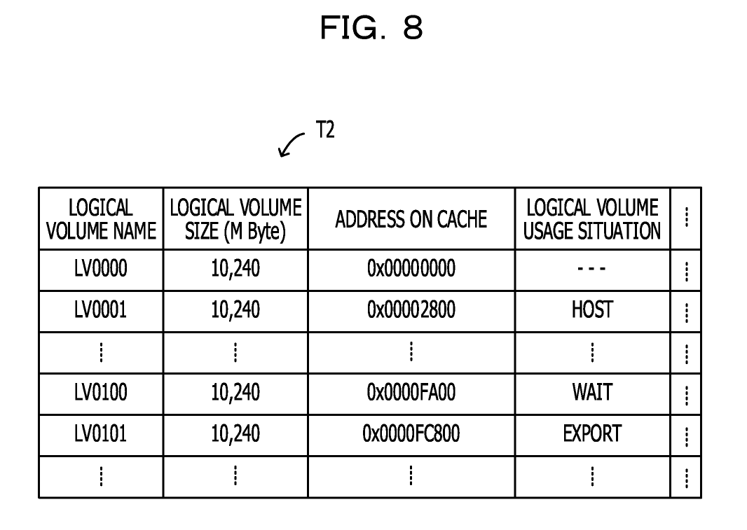

The “cache usage rate (%)” is a ratio of the cache usage amount to the cache total amount. The “in-cache LV information” is information indicating the logical volumes cached in the cache area, and the LV information management table illustrated in FIG. 8 is registered in each cache area.

FIG. 8 illustrates an exemplary configuration of the LV information management table. “Logical volume name”, “logical volume size (M Byte)”, “address on cache”, and “logical volume usage situation” are registered in the LV information management table T2 as the management information of each logical volume stored in the cache area.

The “logical volume name” is information for identifying the logical volume. The “logical volume size (M Byte)” is a data size of the logical volume. The “address on cache” is an initial address of the logical volume in the cache area.

The “logical volume usage situation” indicates which kind of use state the logical volume is in. For example, “---” indicates a situation where this logical volume is not used in any processing. “Host” indicates a situation where this logical volume is used in the host I/O processing. “EXPORT” indicates a situation where this logical volume is used in the export processing (except for the following “Wait” situation). “Wait” indicates a situation where this logical volume stands by in mid-course of the export processing.

In this manner, the logical volumes cached in the disc array apparatus 500 is managed by preparing the above-mentioned cache information management table T1 and the LV information management table T2 in the virtual tape apparatus 200.

On the other hand, the EXPORT information management table T3 and the EXPORT LV information management table T4 are generated when an instruction of the export processing is issued from the host apparatus 400 to the virtual tape apparatus 200.

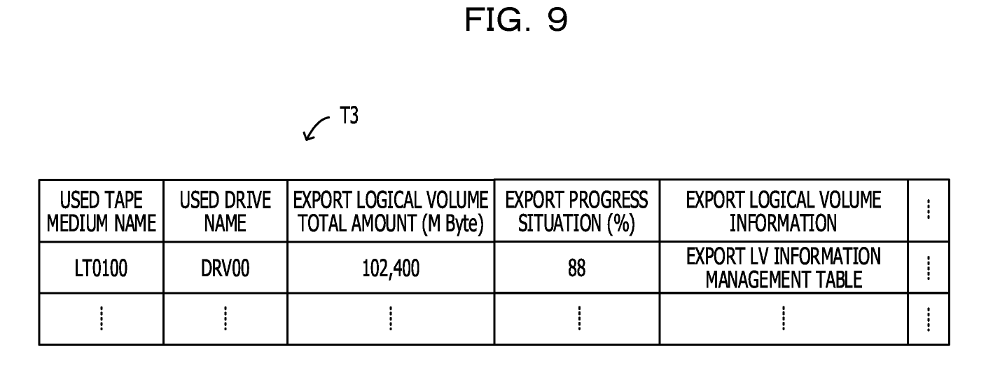

FIG. 9 illustrates an exemplary configuration of an EXPORT information management table. “Used tape medium name”, “used drive name”, “export logical volume total amount (M Byte)”, “export progress situation”, and “export logical volume information” are registered in the EXPORT information management table T3 as the management information of each magnetic tape as a write destination in the export processing.

The “used tape medium name” is information for identifying a currently used magnetic tape. The “used drive name” is information for identifying a currently used tape drive. The “export logical volume total amount (M Byte)” is a data total capacity of the logical volume to be exported.

A value indicated by the “export progress situation” is a percentage of data where the export processing is completed to the export logical volume total amount, and the export processing is completed at 100 (%). The “export logical volume information” is information of the logical volume specified as the export target, and the EXPORT LV information management table is registered for each of the used magnetic tapes.

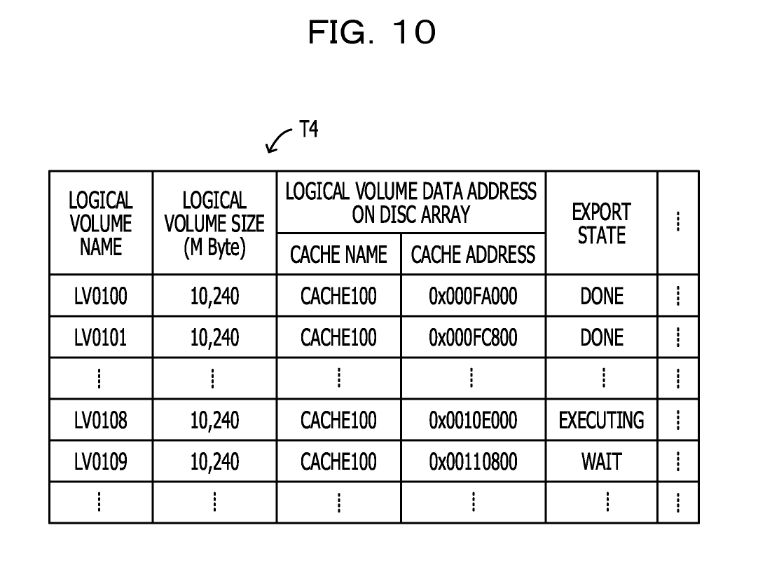

FIG. 10 illustrates an exemplary configuration of an EXPORT LV information management table. “Logical volume name”, “logical volume size (M Byte)”, “logical volume data address on disc array”, and the “export state” are registered in the EXPORT LV information management table T4 as the management information of each logical volume specified as the export target.

The “logical volume name” is information for identifying the logical volume specified as the export target. The “logical volume size (M Byte)” is a data size of the logical volume.

The “logical volume data address on disc array” has items of “cache name” and “cache address”. The “cache name” is information for identifying the cache area where the logical volume is cached. The “cache address” is an initial address of the logical volume in this cache area.

The “export state” indicates the export processing state of the logical volume. For example, “DONE” indicates that the export to the magnetic tape is completed. “EXECUTING” indicates that the export is being conducted to the magnetic tape. “WAIT” indicates a waiting state for the export.

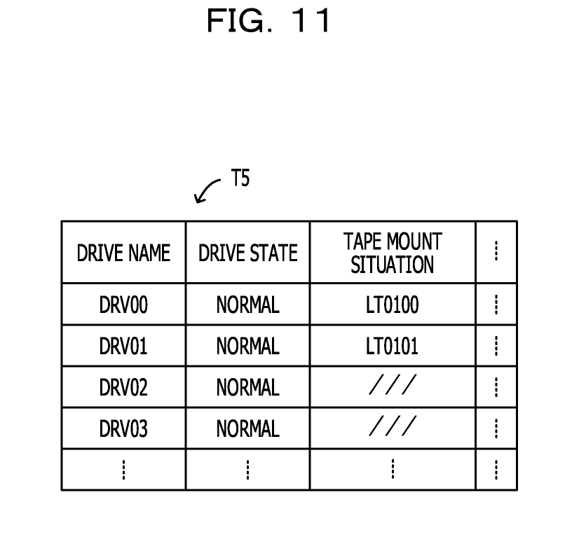

FIG. 11 illustrates an exemplary configuration of a tape drive information table. “Drive name”, “drive state”, and “tape mount situation” are registered in the tape drive information table T5 as management information of each tape drive provided to the tape library apparatus 300.

The “drive name” is information for identifying the tape drive. The “drive state” indicates a state of the tape drive. For example, in a case where “normal” is registered, this tape drive may be used. “Error” indicates a failure state, and “disable” indicates that this tape drive is disabled. Therefore, the tape drive where the “error” or the “disable” is registered is not used. The tape drive that is not to be used is not counted as drive resource.

The “tape mount situation” indicates a mount situation of the magnetic tape. When the tape medium is mounted to the tape drive, for example, a label name of the tape medium is filled in. In a case where the tape medium is not mounted to the tape drive, “///” is filled in.

Herein, before a description is given on a detailed operation of a second embodiment, a problem at the time of the conflict between the export processing and the host I/O processing with respect to the same logical volume will be described.

In the above-mentioned description, when the logical volume is registered in the EXPORT LV information management table T4 of FIG. 10, the “logical volume usage situation” in the LV information management table T2 of FIG. 8 becomes “EXPORT” with respect to this logical volume. The “logical volume usage situation” in the LV information management table T2 becomes “---” at a timing when the “export state” in the EXPORT LV information management table T4 is “DONE” (a timing when the export to the tape medium is completed).

Therefore, it is determined that the conflict (in processing with respect to the same logical volume) occurs in a case where the host write request is issued from the host apparatus 400 to the logical volume where the “logical volume usage situation” in the LV information management table T2 is “EXPORT”.

Up to now, the host I/O processing is executed by priority and the export processing is aborted if the logical volume where the host I/O processing is to be executed conflicts against the logical volume where the export processing is being executed. This is because, the virtual tape apparatus generally does not have a function of executing plural processing at the same time with respect to the same logical volume, and a priority level of the host I/O processing is set higher than that of the export processing, for example.

However, if the entire export processing is aborted and the export processing is thereafter conducted again at the time of the occurrence of the conflict, it takes more time to complete the export processing. Furthermore, the following problems (1) to (3) also occur.

(1) The export processing that has been executed until the conflict in processing with respect to the same logical volume occurs is wasted (waste of time). Since the export processing also includes writing data to the magnetic tape, the processing time for the following (1a) to (1d) is also wasted in addition to the write time at this time (it is noted that the write time depends on the data amount and takes several tens of seconds to several minutes In the case of the data of several G Bytes).

(1a) Time used for mounting the tape cartridge to the drive (for example, ten-odd seconds).

(1b) Time for loading the magnetic tape medium after the tape cartridge is mounted (for example, several tens of seconds to several minutes since positioning to a read/write start position is included).

(1c) Time for unloading the magnetic tape medium after the write is completed (for example, several tens of seconds).

(1d) Time for demounting the tape cartridge from the drive (for example, ten-odd seconds).

(2) The export instruction from the host is used to execute the aborted export processing again (waste of human resources).

(3) An operation schedule is managed on a user (client) side so that the conflict of logical volume between the host I/O processing and the export processing does not occur, and the operation schedule management is cumbersome and time-consuming. Particularly, in recent years, the amount of data stored in a virtual tape system library is increased, and the amount of data to be backed up is also increased. Therefore, it is being difficult to execute the export processing during a period such as nighttime where the host I/O processing is not executed.

Next, an operation of the storage system 100 according to the second embodiment in a case where the conflict in processing with respect to the same logical volume occurs will be described in detail. Up to now, the export processing is unconditionally aborted in a case where the conflict in processing with respect to the same logical volume between the host write processing and the export processing occurs, but according to the second embodiment, the following controls (1) to (6) are carried out.

(1) A rule is set in which the export processing is continued and the host write processing is put on standby in a case where the write to the export magnetic tape with respect to all the specified logical volumes is almost done (for example, several M Bytes).

In this case, the export progress situation is obtained from the “export progress situation” in the EXPORT information management table T3 of FIG. 9. To determine “almost done”, a threshold for recognizing the data-write remaining amount (M Byte) corresponding to the remaining data amount to be written for the export is set.

(2) In a case where the host write processing is prioritized, the export processing is interrupted and then resumed at a timing when execution of the export processing becomes available. An export resumption waiting time (sec) is set for the timing of the resumption.

(3) With regard to the logical volume in which the data is being written to the export magnetic tape (the “export state” in the EXPORT LV information management table T4 of FIG. 10 is “EXECUTING”) at the time of the interruption of the export processing, the data that has been written halfway through to the export magnetic tape is invalidated, and the write is executed from the leading part of the logical volume at the time of the resumption.

(4) In a case where the resources of other tape drives are sufficient at the time of the interruption of the export processing (a case where the resources are sufficient even when the drive used for the conflicting host I/O processing is also included), a control is carried out where the unloading and the demounting of the export magnetic tape are not conducted.

(5) A control is executed to determine whether or not the export processing and the host write processing may be executed in parallel with each other. The parallel execution itself may be realized by duplicating the logical volume of the processing target on the disc array apparatus 500 as a control closed within the virtual tape. Since the duplication of the logical volume data on the disc array apparatus 500 is faster than the data write to the magnetic tape, it takes a shorter time than the fresh start of the export processing.

When the determination on whether or not the parallel execution is available is carried out, a threshold is first set for the “cache usage rate” in the cache information management table T1 of FIG. 7. It is then determined that the parallel execution is available in a case where both the following conditions are satisfied. That is, a usage rate (%) of the areas on the disc array apparatus 500 after the logical volume duplication is lower than or equal to the threshold, and resources of the drives are sufficient even when the parallel execution is carried out.

(6) A control depending on whether the current logical volume before being updated by the host write processing is subjected to the export processing or a new logical volume after the update is subjected to the export processing is executed.

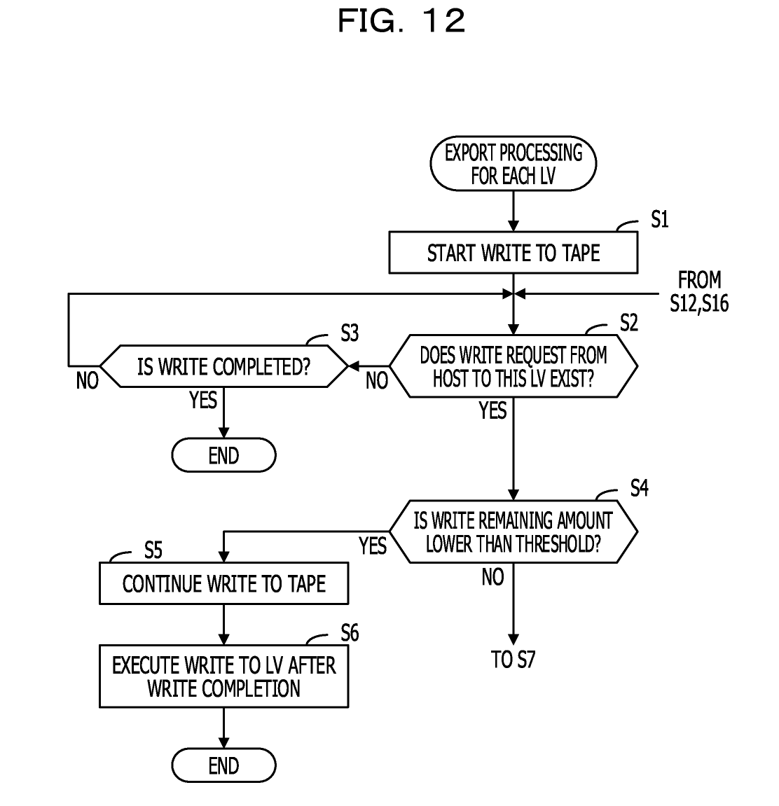

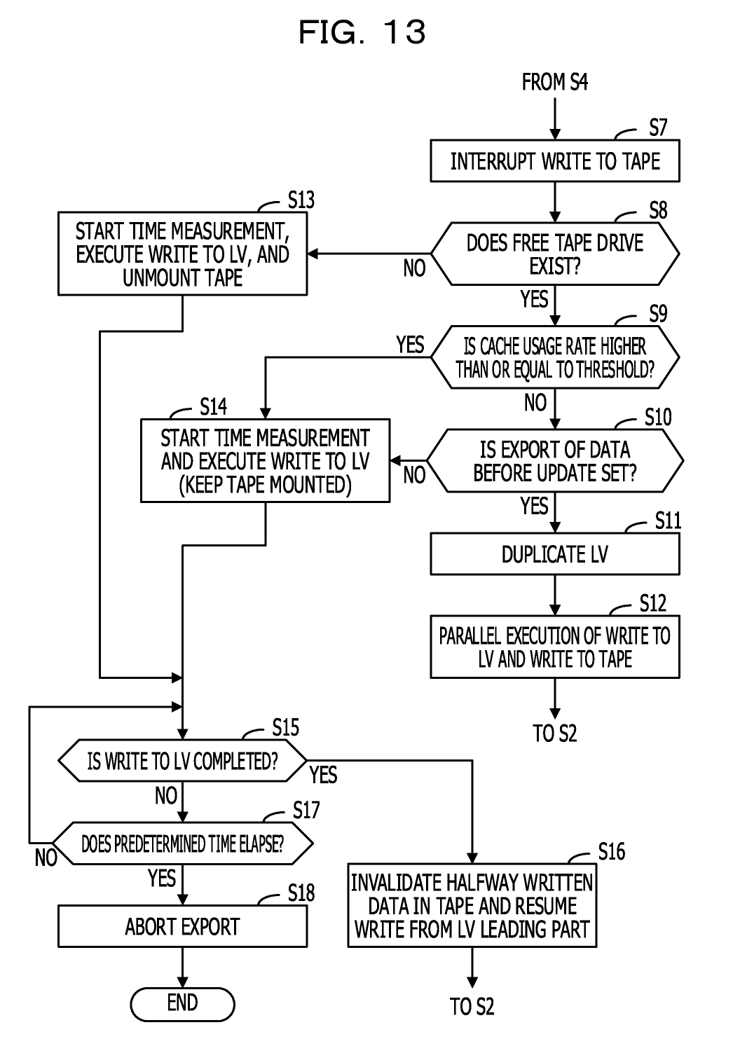

Next, a flow of an entire operation will be described by using flow charts. FIG. 12 and FIG. 13 are flow charts of an operation by the control apparatus. The processing in FIG. 12 and FIG. 13 is executed for each of the logical volumes specified as the target of the export processing. That is, the processing in FIG. 12 and FIG. 13 is executed with respect to each of the logical volumes registered in the EXPORT LV information management table T4 of FIG. 10.

Hereinafter, the write to the export magnetic tape is called “export write” so as to be distinguished from the write (host write) in response to the request from the host apparatus 400.

(S1) The I/O control unit 230 starts the export write to the export magnetic tape with respect to the data of the logical volume as the export processing. At this time, the I/O control unit 230 updates the “export state” of the record of the relevant logical volume in the EXPORT LV information management table T4 from “WAIT” to “EXECUTING”.

(S2) The I/O control unit 230 determines whether or not the host write request with respect to the relevant logical volume from the host apparatus 400 exists. The process proceeds to S3 when the host write request does not exist, and the process proceeds to S4 when the host write request exists.

(S3) The I/O control unit 230 determines whether or not the export write to the export magnetic tape of the entire logical volume is completed. In a case where the export write is completed, the export processing of the relevant logical volume is ended. The process returns to S2 in a case where the export write is not completed.

It is noted that the following process is executed in a case where the export write is completed. The I/O control unit 230 updates the “export state” of the record of the relevant logical volume in the EXPORT LV information management table T4 from “EXECUTING” to “DONE”. The I/O control unit 230 also invalidates the relevant logical volume on the disc array apparatus 500. Specifically, the I/O control unit 230 deletes the record where the relevant logical volume is registered and where the “logical volume usage situation” is “EXPORT” from the LV information management table T2.

(S4) The I/O control unit 230 determines whether or not the data-write remaining amount is lower than the threshold on the basis of the “export logical volume total amount” and the “export progress situation” of the relevant record in the EXPORT information management table T3. The process proceeds to S5 when the data-write remaining amount is lower than the threshold, and the process proceeds to S7 when the data-write remaining amount is higher than or equal to the threshold.

(S5) Since the write to the export magnetic tape with respect to all the specified logical volumes is almost done, the I/O control unit 230 continues the export write to the magnetic tape.

(S6) The I/O control unit 230 executes the host write processing on the relevant logical volume after the completion of the export write to the magnetic tape with respect to the relevant logical volume in a case where the logical volume of the export write target is the last logical volume among the specified logical volumes (In the case of the lastly registered logical volume in the EXPORT LV information management table T4).

Although not illustrated in the drawings, when the export write to the relevant logical volume is completed, the I/O control unit 230 updates the “export state” of the record of the relevant logical volume in the EXPORT LV information management table T4 from “EXECUTING” to “DONE”. The I/O control unit 230 also invalidates the relevant logical volume on the disc array apparatus 500.

(S7) The I/O control unit 230 interrupts the export write since a considerable amount of the remaining write data of the entire export processing still exists. At this time, the I/O control unit 230 updates the “export state” of the record of the relevant logical volume in the EXPORT LV information management table T4 from “EXECUTING” to “WAIT”.

(S8) The I/O control unit 230 refers to the tape drive information table T5 to determine whether or not a free tape drive exists. The process proceeds to S9 in a case where a free tape drive exists, and the process proceeds to S13 in a case where no free tape drive exists.

(S9) The I/O control unit 230 refers to the cache information management table T1 and obtains a cache usage rate to determine whether or not the cache usage rate is higher than or equal to a threshold. The process proceeds to S14 in a case where the cache usage rate is higher than or equal to the threshold, and the process proceeds to S10 in a case where the cache usage rate is lower than the threshold.

(S10) The I/O control unit 230 determines whether or not the export processing of the data before the update is set. This setting is, for example, specified from the host apparatus 400 when the export is requested or this setting is made in advance. The process proceeds to S11 in a case where the export processing of the data before the update is set, and the process proceeds to S14 in a case where this processing is not set yet.

(S11) The I/O control unit 230 duplicates the logical volume in the disc array apparatus 500.

(S12) The I/O control unit 230 uses the data of one of the duplicated logical volumes to execute the export write processing and also executes the host write with respect to the other duplicated logical volume in parallel with this processing. The process then returns to S2.

In a case where the export write processing is executed, the data of the halfway export write processing is invalidated, and the tape is rewound to the leading part of the relevant logical volume to resume the write from the leading part of the relevant logical volume (the same processing as S16 which will be described later).

A detail of the processing in S11 and S12 will be described later.

(S13) The I/O control unit 230 starts time measurement in a case where no free tape drive exists. The I/O control unit 230 executes the host write with respect to the logical volume on the disc array apparatus 500 and also demounts the export magnetic tape corresponding to the current export write destination from the tape drive. The process proceeds to S15.

The I/O control unit 230 mounts the library magnetic tape to the tape drive from which the export magnetic tape has been demounted. After the host write to the logical volume on the disc array apparatus 500 is completed and the host apparatus 400 is notified of the write completion, the I/O control unit 230 copies all the data of this logical volume from the disc array apparatus 500 to the library magnetic tape.

(S14) The I/O control unit 230 starts the time measurement in a case where the cache usage rate is higher than or equal to the threshold or a case where the data before the update is not subjected to the export processing. The I/O control unit 230 also executes the host write with respect to the logical volume on the disc array apparatus 500. At this time, the I/O control unit 230 keeps the export magnetic tape corresponding to the current export write destination mounted to the tape drive.

The I/O control unit 230 also mounts the library magnetic tape to the free tape drive. After the host write to the logical volume on the disc array apparatus 500 is completed and the host apparatus 400 is notified of the write completion, the I/O control unit 230 copies all the data of this logical volume from the disc array apparatus 500 to the library magnetic tape.

(S15) The I/O control unit 230 determines whether or not the host write with respect to the logical volume is completed. The process proceeds to S16 in a case where the host write is completed, and the process proceeds to S17 in a case where the host write is not yet completed.

In S15 after S13, it is determined that the host write is completed when the host write to the logical volume on the disc array apparatus 500 is completed and furthermore the copy to the library magnetic tape of this logical volume is completed. On the other hand, in S15 after S14, it may be determined that the host write is completed when the host write to the logical volume on the disc array apparatus 500 is completed.

(S16) The I/O control unit 230 invalidates the halfway written data of the relevant logical volume on the export magnetic tape after the completion of the host write processing and rewinds the magnetic tape to the leading part of the relevant logical volume to resume the export write from the leading part of this logical volume. That is, the I/O control unit 230 reads out the data of the logical volume updated in S13 or S14 on the disc array apparatus 500 from the leading part to transfer the read data to the export magnetic tape. The write is resumed from the leading part of the relevant logical volume, and the halfway written data of the same logical volume is overwritten in the export magnetic tape. The “export state” of the record of the relevant logical volume in the EXPORT LV information management table T4 is updated from “WAIT” to “EXECUTING”.

In S16 after S13, the library magnetic tape demounted from the tape drive in S13 is mounted to a free tape drive at this time.

(S17) The I/O control unit 230 determines whether or not a value of the time measurement passes a predetermined time (export resumption waiting time) that has previously been set. The process returns to S15 in a case where the time measurement does not pass the predetermined time. The process proceeds to S18 in a case where the time measurement value passes the predetermined time.

(S18) Since the host write processing is not ended even when the time measurement value passes the export resumption waiting time, the I/O control unit 230 aborts the entire export processing. At this time, the I/O control unit 230 updates the “export state” of all the records in the EXPORT LV information management table T4 to “WAIT”. The I/O control unit 230 also updates the value of the “export progress situation” of the corresponding record in the EXPORT information management table T3 to “0”.

As described above, the control apparatus 201 interrupts the export write in a case in which the conflict occurs and thereafter resumes the export write from the leading position of the relevant logical volume. According to this, it is possible to execute the export processing in a shorter time than the fresh start of the entire export processing.

Since the halfway written data of the logical volume in the export magnetic tape is invalidated at the time of the interruption of the export write, it is possible to maintain the consistency of the logical volume in which the conflict occurs. Furthermore, by providing the function of appropriately interrupting the export write as described above, the host write may be executed without delay and also the response time of the host write is shortened.

The control apparatus 201 duplicates the logical volume in which the conflict occurs. The control apparatus 201 resumes the export by using the data of one of the duplicated logical volumes also executes the host write with respect to the other logical volume in parallel. According to this, not only the response time of the host write may be shortened, but also the interruption time of the export write may be shortened. Furthermore, while the host write is executed by priority, the export processing may be continued by using the logical volume before the update instead of the logical volume after the update by the host write.

The above-mentioned parallel execution is conducted only in a case where the cache area on the disc array apparatus 500 has a certain size of the free space. According to this, it is possible to reliably execute the duplication processing of the logical volume.

In a case where the logical volume in which the data is updated by the host write processing is subjected to the export processing after the export processing is interrupted at the time of the conflict, the control apparatus 201 resumes the export processing on the basis of a predetermined time set in advance.

That is, the control apparatus 201 executes the export resumption processing to the logical volume after the update in a case where the host write processing with respect to the logical volume in which the conflict occurs is completed within the predetermined time and aborts the export processing to the logical volume after the update in a case where the host write processing is not yet completed within the predetermined time. According to this, even when an abnormity is generated in the host write processing executed by priority, it is possible to resume the export processing within a certain period of time.

Furthermore, the control apparatus 201 executes the host write without demounting the export magnetic tape from the tape drive in a case where a free tape drive exists after the export processing is interrupted at the time of the conflict. According to this, the time for mounting the export magnetic tape to the tape drive again is not prepared, and the export may be resumed shortly.

The control apparatus 201 compares the data-write remaining amount of the entire export processing with a threshold. The export processing is continued in a case where the data-write remaining amount is lower than the threshold, and the host write processing is executed after the completion of the export processing. According to this, in a case where the export processing is almost finished, this export processing is ended, and the host I/O processing is executed. Therefore, it is possible to shorten the time used for the export processing. In addition, the response delay time of the host write is suppressed within a certain range.

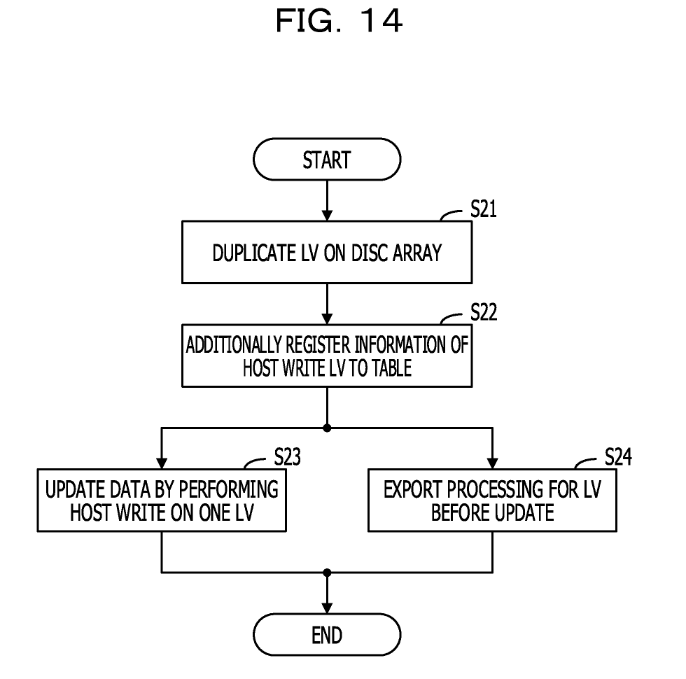

Next, FIG. 14 is a flow chart of processing in a case where export processing and host-write processing are executed in parallel with each other.

(S21) The I/O control unit 230 duplicates the logical volume in the export processing on the disc array apparatus 500. Specifically, the I/O control unit 230 copies all the data of the relevant logical volume on the disc array apparatus 500 onto the disc array apparatus 500. The copied logical volume is the target of the host write.

(S22) The I/O control unit 230 generates a record of the copied logical volume in the LV information management table T2 and sets the “logical volume usage situation” of the generated record as “Host”. According to this, two records corresponding to the same logical volume exist in the LV information management table T2 where one of them indicates the volume for the export write and the other one indicates the volume for the host write.

The above-mentioned processing in S21 and S22 corresponds to the processing in S11 of FIG. 13.

(S23) The I/O control unit 230 writes the data for which the host write is requested to the logical volume for the host write among the duplicated logical volumes.

Although not illustrated in the drawings, the I/O control unit 230 mounts the library magnetic tape to the free tape drive. After the host write is completed and the host apparatus 400 is notified of the write completion, the I/O control unit 230 copies all the data of this logical volume from the disc array apparatus 500 to the library magnetic tape.

(S24) The I/O control unit 230 reads out the data of the logical volume for the export among the duplicated logical volumes from the leading part to write the read data to the export magnetic tape. The data of the logical volume read out at this time is the data before the update by the host write.

Similarly as in S16 of FIG. 13, the I/O control unit 230 invalidates the halfway written data of the relevant logical volume on the export magnetic tape and rewinds the magnetic tape to the leading part of the relevant logical volume to resume the export write from the leading part of this logical volume. The write is resumed from the leading position of the relevant logical volume in the export magnetic tape, and the halfway written data of the same logical volume is overwritten. The “export state” of the record of the relevant logical volume in the EXPORT LV information management table T4 is updated from “WAIT” to “EXECUTING”.

The above-mentioned processing in S23 and S24 corresponds to the processing in S12 of FIG. 13. The processing in S24 may be executed in parallel with the processing in S23.

The logical volume for the export among the duplicated logical volumes in the disc array apparatus 500 is invalidated after the export write of the relevant logical volume is completed (“Yes” in S3 of FIG. 12).

As described above, according to the second embodiment, in a case where the export processing and the host write processing with respect to the same logical volume conflict against each other, the export processing is interrupted, the data on the magnetic tape is invalidated, and the export is continued from the leading part of the logical volume. According to this configuration, the export processing time may be shortened as compared with a case where the entire export processing is executed again from the beginning.

The export processing executed until the conflict occurs is not wasted. For example, the time for rewinding the export magnetic tape to the beginning or the time for mounting another export magnetic tape again is not prepared.

Furthermore, the user does not involve the operation of managing the operation schedule in which the conflict of logical volume between the host I/O processing and the export processing does not occur and may use the system without paying attention to the conflict between the host I/O processing and the export processing.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage system comprising:
a library apparatus configured to
store therein a plurality of portable recording media, and
read data from or write data to the plurality of portable recording media;
a storage apparatus configured to
temporarily store therein data of a logical volume, the stored data being to be recorded on a recording medium among the plurality of portable recording media; and
a control apparatus including:
a processor configured to
execute a copy processing of copying data of a plurality of logical volumes from the storage apparatus to a first recording medium among the plurality of portable recording media, the copy processing including
a read processing of reading first data of a first logical volume among the plurality of logical volumes from the storage apparatus, and
a first write processing of writing the first data to the first recording medium,
execute a second write processing of writing second data of the first logical volume to the storage apparatus,
interrupt the first write processing and execute the second write processing in a case where a conflict occurs between the second write processing and the first write processing during execution of the copy processing,
invalidate data written to the first recording medium through the interrupted first write processing, and
resume the copy processing from a leading part of the first logical volume.

2. The storage system according to claim 1, wherein
the processor is configured to
duplicate the first data when the first write processing is interrupted,
resume the copy processing by executing the first write processing by using one of the duplicated data, and
execute the second write processing by overwriting another one of the duplicated data in parallel with the first write processing in the resumed copy processing.

3. The storage system according to claim 2, wherein
the processor is configured to
determine a capacity of a free space of the storage apparatus when the first write processing is interrupted,
perform the parallel execution of the first write processing and the second write processing in a case where the capacity is higher than a predetermined threshold,
refrain from the duplication and execute the second write processing in a case where the capacity is lower than or equal to the predetermined threshold, and
execute the first write processing in the resumed copy processing using the second data written to the storage apparatus through the second write processing.

4. The storage system according to claim 1, wherein
the processor is configured to
execute the second write processing when the first write processing is interrupted, and
execute the first write processing in the resumed copy processing using the second data written to the storage apparatus through the second write processing.

5. The storage system according to claim 4, wherein
the processor is configured to
execute the first write processing in the resumed copy processing in a case where the second write processing is completed within a predetermined time after the first write processing is interrupted, and
abort the copy processing in a case where the second write processing is not yet completed within the predetermined time.

6. The storage system according to claim 4, wherein
the library apparatus includes a plurality of drive apparatuses each configured to read data from or write data to one of the plurality of portable recording media, and
the processor is configured to
demount the first recording medium from a drive apparatus in a case where no free drive apparatus exists in the library apparatus when the first write processing is interrupted, and
execute the second write processing without demounting the first recording medium from the drive apparatus in a case where a free drive apparatus exists in the library apparatus.

7. The storage system according to claim 1, wherein
the processor is configured to
determine an amount of data remaining to be copied in the copy processing when the conflict occurs,
continue the first write processing without the interruption in a case where the amount is lower than a predetermined threshold, and
execute the second write processing after the copy processing is completed.

8. A control apparatus comprising:
a processor configured to
execute a copy processing of copying data of a plurality of logical volumes from a storage apparatus to a first recording medium among a plurality of portable recording media, the copy processing including
a read processing of reading first data of a first logical volume among the plurality of logical volumes from the storage apparatus, and
a first write processing of writing the first data to the first recording medium,
execute a second write processing of writing second data of the first logical volume to the storage apparatus,
interrupt the first write processing and execute the second write processing in a case where a conflict occurs between the second write processing and the first write processing during execution of the copy processing,
invalidate data written to the first recording medium through the interrupted first write processing, and
resume the copy processing from a leading part of the first logical volume.

9. A method for controlling a storage system, the method comprising:
executing, by a control apparatus, a copy processing of copying data of a plurality of logical volumes from a storage apparatus to a first recording medium among a plurality of portable recording media, the copy processing including
a read processing of reading first data of a first logical volume among the plurality of logical volumes from the storage apparatus, and
a first write processing of writing the first data to the first recording medium;
executing a second write processing of writing second data of the first logical volume to the storage apparatus;
interrupting the first write processing and execute the second write processing in a case where a conflict occurs between the second write processing and the first write processing during execution of the copy processing;
invalidating data written to the first recording medium through the interrupted first write processing; and
resuming the copy processing from a leading part of the first logical volume.

10. The method according to claim 9, wherein
the control apparatus
duplicates the first data when the first write processing is interrupted,
resumes the copy processing by executing the first write processing by using one of the duplicated data, and
executes the second write processing by overwriting another one of the duplicated data in parallel with the first write processing in the resumed copy processing.

11. The method according to claim 10, wherein
the control apparatus
determines a capacity of a free space of the storage apparatus when the first write processing is interrupted,
performs the parallel execution of the first write processing and the second write processing in a case where the capacity is higher than a predetermined threshold,
refrains from the duplication and execute the second write processing in a case where the capacity is lower than or equal to the predetermined threshold, and
executes the first write processing in the resumed copy processing using the second data written to the storage apparatus through the second write processing.

12. The method according to claim 9, wherein
the control apparatus
executes the second write processing when the first write processing is interrupted, and
executes the first write processing in the resumed copy processing using the second data written to the storage apparatus through the second write processing.

13. The method according to claim 12, wherein
the control apparatus
executes the first write processing in the resumed copy processing in a case where the second write processing is completed within a predetermined time after the first write processing is interrupted, and
aborts the copy processing in a case where the second write processing is not yet completed within the predetermined time.

14. The method according to claim 12, wherein
the control apparatus
demounts the first recording medium from a drive apparatus in a case where no free drive apparatus exists when the first write processing is interrupted, and
executes the second write processing without demounting the first recording medium from the drive apparatus in a case where a free drive apparatus exists.

15. The method according to claim 9, wherein
the control apparatus
determines an amount of data remaining to be copied in the copy processing when the conflict occurs,
continues the first write processing without the interruption in a case where the amount is lower than a predetermined threshold, and
executes the second write processing after the copy processing is completed.
